(19) United States
(12) Patent Application Publication
(10) Pub. No.: US 2011/0107087 A1
(43) Pub. Date: May 5, 2011

(54) APPARATUS AND METHOD FOR REFRESHING MASTER SESSION KEY IN WIRELESS COMMUNICATION SYSTEM

(75) Inventors: Ji-Cheol LEE, Suwon-si (KR); Young-Kyo BAEK, Seoul (KR); Yegin ALPER, Istanbul (TR); Dong-Keon KONG, Suwon-si (KR); Jung-Shin PARK, Seoul (KR); Nae-Hyun LIM, Seoul (KR); Se-Hoon KIM, Seoul (KR)

(73) Assignee: SAMSUNG ELECTRONICS CO. LTD., Suwon-si (KR)

(21) Appl. No.: 12/914,178

(22) Filed: Oct. 28, 2010

(30) Foreign Application Priority Data
Nov. 4, 2009 (KR) 10-2009-0105767

(51) Int. Cl. H04L 29/06; H04L 9/00

(52) U.S. Cl. 713/155

(57) ABSTRACT

A Master Session Key (MSK) refresh in a wireless communication system is provided. A MSK refreshing method MSK includes when receiving a first Media Access Control (MAC) message including MSK refresh indication information from a Base Station (BS), generating, at a Mobile Station (MS), an Extended Master Session Key (EMSK)_Hash by applying a hash function to an EMSK and sending a second MAC message including the EMSK_Hash, sending, at the BS, a context request message including the EMSK_Hash to an Access Service Network GateWay (ASN-GW), sending, at the ASN-GW, an authentication request message including the EMSK_Hash to an authentication server, when receiving the authentication request message including the EMSK_Hash, confirming, at the authentication server, the same EMSK as the MS based on the EMSK_Hash, determining an MSK1 using the EMSK, and sending an authentication accept message including the MSK1 to the ASN-GW, and sending, at the ASN-GW, a context report message including an Authorization Key (AK) context to the BS.

### PRIORITY

This application claims the benefit under 35 U.S.C. §119(a) of a Korean patent application filed in the Korean Intellectual Property Office on Nov. 4, 2009, and assigned Serial No. 10-2009-0105767, the entire disclosure of which is hereby incorporated by reference.

### BACKGROUND OF THE INVENTION

1. Field of the Invention

The present invention relates generally to a wireless communication system. More particularly, the present invention relates to an apparatus and a method for refreshing a Master Session Key (MSK) in a wireless communication system.

2. Description of the Related Art

A Fourth Generation (4G) communication system, which is a next-generation communication system, is being developed and commercialized to provide users with various services at a data rate above 100 Mbps. Particularly, the 4 G communication systems are advancing in order to support high speed services by guaranteeing mobility and Quality of Service (QoS) in Broadband Wireless Access (BWA) communication systems such as wireless Local Area Network (LAN) systems and wireless Metropolitan Area Network (MAN) systems. Its representative communication system is an Institute of Electrical and Electronics Engineers (IEEE) 802.16 communication system.

Recently, standardization of IEEE 802.16m, which is advanced from the IEEE 802.16e standard, is under way. In terms of the deployment of network equipment, a system integrating both IEEE 802.16e and IEEE 802.16m, rather than only IEEE 802.16m, will be implemented as a transitional stage. Naturally, when a mobile station migrates from the IEEE 802.16e system to the IEEE 802.16e/16m integrated system, the system must control zone switching to the new system because a corresponding region of the mobile station has different characteristics from the legacy system supporting the mobile station.

IEEE 802.16e/16m adopts an Extensible Authentication Protocol (EAP) for the sake of data security and a station authentication. According to the EAP, the mobile station generates a Pairwise Master Key (PMK) using a Master Session Key (MSK), and performs encryption with the PMK. The mobile station acquires the MSK through an EAP authentication procedure, an EAP re-authentication procedure, or a key agreement procedure.

The MSK of the mobile station cannot be shared with different authenticators. Hence, when an authenticator for the IEEE 802.16e standard and an authenticator for the IEEE 802.16m standard exist as separate equipment, the mobile station needs to conduct the EAP re-authentication procedure after the zone switching. Accordingly, the time delay taken to complete the zone switching extends, and thus the service quality is degraded.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for reducing a time delay taken to complete zone switching in a wireless communication system.

Another aspect of the present invention is to provide an apparatus and a method for reducing a time delay taken to refresh a Master Session Key (MSK) in a wireless communication system.

Yet another aspect of the present invention is to provide an apparatus and a method for refreshing an MSK without an Extensible Authentication Protocol (EAP) re-authentication procedure in a wireless communication system.

Still another aspect of the present invention is to provide an apparatus and a method for refreshing an MSK using an Extended Master Session Key (EMSK) in a wireless communication system.

According to an aspect of the present invention, a method for refreshing a MSK in a wireless communication system is provided. The method includes, when receiving a first Media Access Control (MAC) message including MSK refresh indication information from a Mixed Base Station (BS), generating, at a Advanced Mobile Station (AMS), EMSK_Hash by applying a hash function to an EMSK, and sending a second MAC message including the EMSK_Hash, sending, at the Mixed BS, a context request message including the EMSK_Hash to an Access Service Network GateWay (ASN-GW), sending, at the ASN-GW, an authentication request message including the EMSK_Hash to an authentication server, when receiving the authentication request message including the EMSK_Hash, confirming, at the authentication server, the same EMSK as the AMS based on the EMSK_Hash, determining an MSK1 using the EMSK, sending an authentication accept message including the MSK1 to the ASN-GW, and sending, at the ASN-GW, a context report message including an Authorization Key (AK) context to the Mixed BS.

According to another aspect of the present invention, a wireless communication system is provided. The system includes an AMS for, when receiving a first MAC message including MSK refresh indication information from a Mixed BS, generating EMSK_Hash by applying a hash function to an EMSK and sending a second MAC message including the EMSK_Hash, the Mixed BS, for sending a context request message including the EMSK_Hash to an ASN-GW, the ASN-GW, for sending an authentication request message including the EMSK_Hash to an authentication server, and when receiving an authentication accept message including an MSK1 from the authentication server, sending a context report message including an AK context to the Mixed BS, and the authentication server for, when receiving the authentication request message including the EMSK_Hash from the ASN-GW, confirming the same EMSK as the AMS based on the EMSK_Hash, determining the MSK1 using the EMSK, and sending the authentication accept message including the MSK1 to the ASN-GW.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram of a wireless communication system according to an exemplary embodiment of the present invention;

FIG. 2 is a diagram of a key hierarchy in a wireless communication system according to an exemplary embodiment of the present invention;

FIG. 3 is a diagram of a signal exchange for refreshing a Master Session Key (MSK) through key agreement in a wireless communication system according to an exemplary embodiment of the present invention;

FIG. 4 is a diagram of a signal exchange for refreshing an MSK through zone switching in a wireless communication system according to an exemplary embodiment of the present invention;

FIGS. 5A, 5B, and 5C are diagrams of signal exchanges for a zone switching using an MSK refreshing in a wireless communication system according to an exemplary embodiment of the present invention;

FIG. 6 is a block diagram of a mobile station in a broadband wireless communication system according to an exemplary embodiment of the present invention;

FIG. 7 is a block diagram of a mixed base station in a broadband wireless communication system according to an exemplary embodiment of the present invention;

FIG. 8 is a block diagram of an Access Service Network GateWay (ASN-GW) in a broadband wireless communication system according to an exemplary embodiment of the present invention; and

FIG. 9 is a block diagram of an authentication server in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for reducing a time delay taken to refresh a Master Session Key (MSK) in a wireless communication system. In particular, the present invention provides an MSK refreshing for zone switching. Herein, the zone switching indicates an access transition between the service according to a legacy system standard and the service according to an advanced system standard of the legacy system. Hereinafter, a region according to the legacy system standard is referred to as a Legacy (L)-zone, and a region according to the advanced system standard is referred to as an M-zone.

Hereafter, while an Orthogonal Frequency Division Multiplexing (OFDM)/Orthogonal Frequency Division Multiple Access (OFDMA) wireless communication system is exemplified, the present invention is equally applicable to other wireless communication systems.

An Institute of Electrical and Electronics Engineers (IEEE) 802.16 system is explained by way of example. Naturally, terms defined in the IEEE 802.16 standard are used. Other terms than terms separately defined should be construed as definitions as described in the IEEE 802.16 standard. Note that the present invention is not limited to the IEEE 802.16 system.

When the MSK needs to be refreshed because of the zone switching, the present invention allows a Advanced Mobile Station (AMS), an authenticator, and an authentication server to share a new MSK using a key agreement message or a message for the same or similar purpose as or to the key agreement message without Extensible Authentication Protocol (EAP) re-authentication. Accordingly, the MSK can be refreshed when the authenticators do not transfer the new MSK or when the authenticator does not receive the old MSK from the authentication server. The terminology MS in this document is used to indicate Advanced Mobile Station which support both IEEE802.16m and IEEE802.16e. The terminology of MS is used interchangeable with AMS.

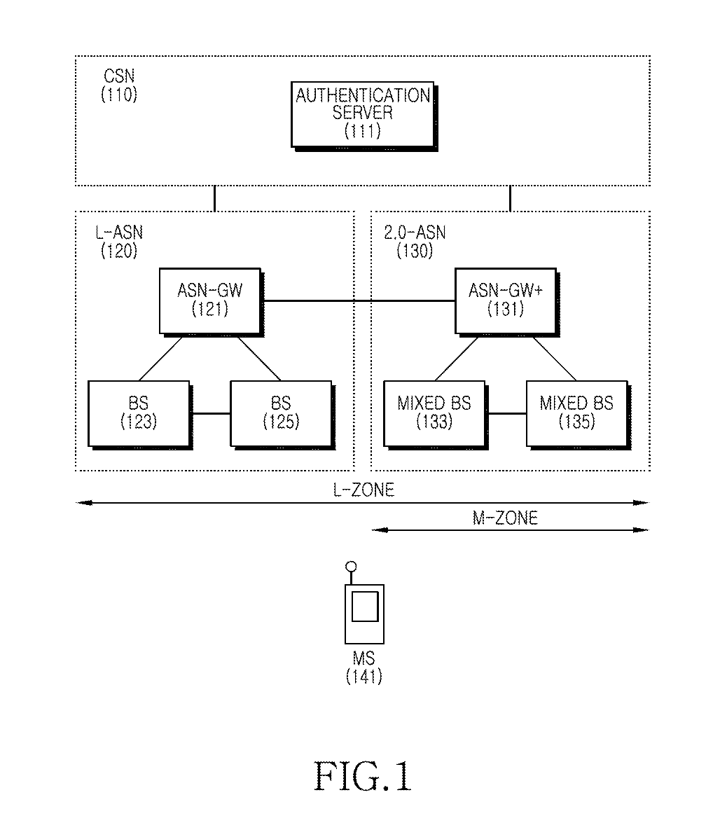

FIG. 1 is a schematic diagram of a wireless communication system according to an exemplary embodiment of the present invention.

Referring to FIG. 1, the wireless communication system includes a Core Service Network (CSN) 110 including an authentication server 111, a Legacy-Access Service Network (L-ASN) 120 including an Access Service Network-GateWay (ASN-GW) 121 and Base Stations (BSs) 123 and 125, and a 2.0-ASN 130 including an ASN-GW+ 131 and mixed BSs 133 and 135, and an MS 141.

The authentication server 111 is responsible for authentication and accounting of the AMS 141. The L-ASN 120 is an access network for the service of the L-zone. The ASN-GW 121 is equipment for the connection between the BSs 123 and 125 and the CSN 110. The 2.0-ASN 130, which is an access network for the service of the M-zone, can provide the service of the L-zone at the same time. The ASN-GW+ 131 is equipment for the interconnection between the mixed BSs 133 and 135 and the CSN 110. The MS 141 is user equipment, and uses the service of the L-zone via the BSs 123 and 125 or the service of the L-zone or the M-zone via the mixed BSs 133 and 135.

The AMS 141 can hand over between the L-zone and the M-zone. The authentication server 111 and the AMS 141 generate an MSK of the AMS 141 according to an EAP. The ASN-GW 121 and the ASN-GW+ 131 can include an authenticator for the corresponding ASN. In this case, the ASN-GW 121 and the ASN-GW+ 131 process the authentication of the MS in the corresponding ASN and generate a security key.

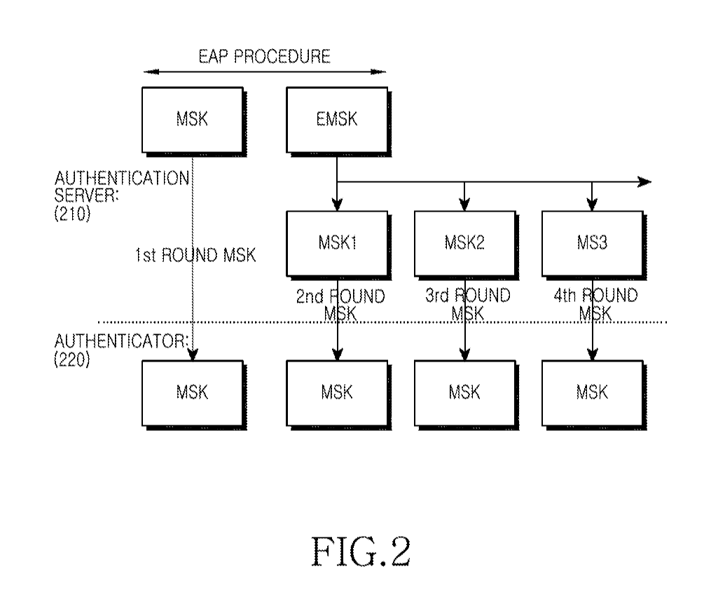

FIG. 2 is a diagram of a key hierarchy in a wireless communication system according to an exemplary embodiment of the present invention.

Referring to FIG. 2, an authentication server 210 generates an MSK and an Extended MSK (EMSK) with an AMS according to the EAP. The MSK is transferred to an authenticator 220 of the ASN to which the AMS is connected. If necessary, additional MSKs are generated from the EMSK. When the MSK needs to be refreshed, the authentication server 210 sends MSK1, MSK2, and MSK3 to the authenticator 220 in sequence without re-authentication. Thus, the authenticator 220 obtains the MSK using the MSK1, the MSK2, and the MSK3.

Now, the MSK refreshing according to an exemplary embodiment of the present invention is explained. Hereinafter, parameters contained in each message are defined as shown in Table 1.

TABLE 1

| Parameter | Description |
|---|---|
| N_BS | NONCE_BS, NONCE generated at the BS. |
| N_MS | NONCE_MS, NONCE generated at the MS. |
| MSK_SN | A sequence number of the MSK. |
| | A parameter for distinguishing the MSK |
| | (e.g., increase as 1, 2 and 3 by 1) |
| EMSK | EMSK obtained through EAP process, and |
| | is generated together with the MSK. (For details, |
| | see RFC3748 section 7.10). |
| EMSK-Hash | Hash value which is generated with EMSK |
| | and other parameters as described in [0042] |
| CMAC | A message authentication scheme of Media Access |
| | Control (MAC) management in 802.16 m. |
| | Herein, indicates CMAC Digest |
| | (for details, see P802.16 m/D1 or P802.16 m/D2). |
| MSK1 | New MSK generated at the authentication server |
| | and the AMS using the EMSK, and another MSK |
| | identified with an indicator of MSK SN = 1. |
| AK context | AK and context relating to the AK, and includes AK, |
| | AK Sequence Number, CMAC Key Count, and so on. |
| H( ) | One-way hash function. Mainly use HMAC-SHA1 |
| | or HMAC-SHA256 (for details, see RFC2104, |
| | RFC2202, and RFC4868). |
| KDF( ) | Key Derivation Function. A mathematical function |
| | for generating another key, in addition to a parameter |
| | relating to Input Key. For example, function such as |
| | Dot16KDF or HMAC can be used. |
| PA_VC | Present Authenticator Validation Code. A hash result |
| | value for validating an old authenticator in the |
| | authenticator shifting process. |
| PA_NONCE | Present Authenticator NONCE. NONCE for |
| | validating the old authenticator in the authenticator |
| | shifting process. |

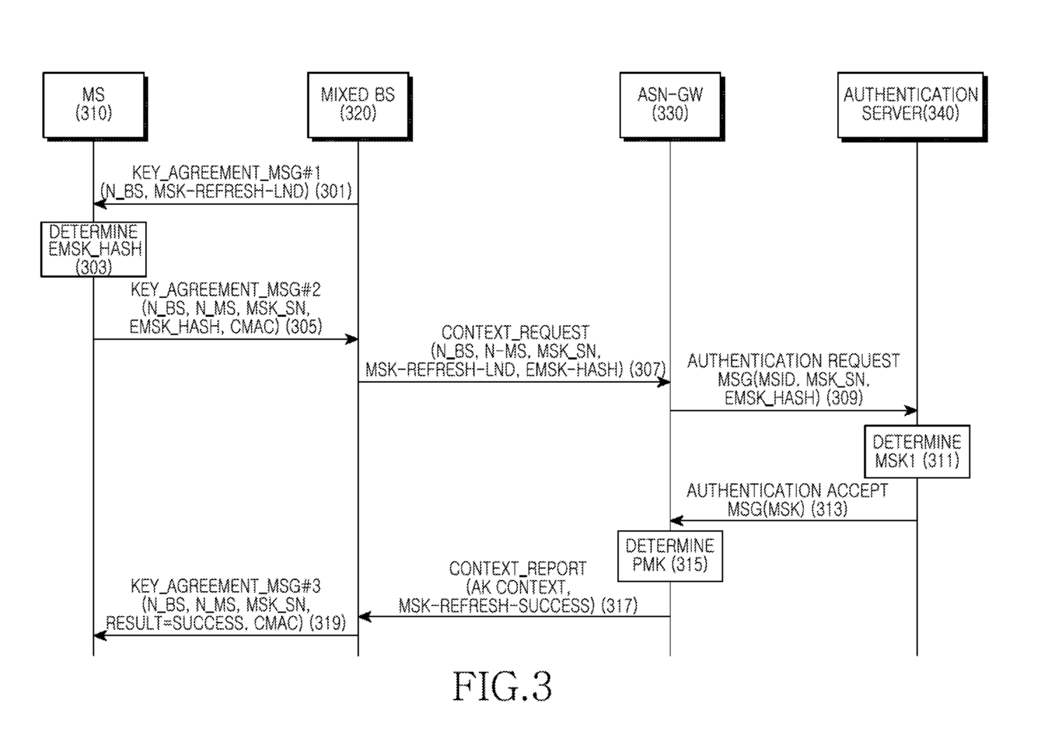

FIG. 3 is a diagram of a signal exchange for refreshing a MSK through key agreement in a wireless communication system according to an exemplary embodiment of the present invention.

Referring to FIG. 3, an MS 310 is accessible to both of the L-zone and the M-zone, a mixed BS 320 can provide both of the L-zone service and the M-zone service, and an ASN-GW 330 can function as an authenticator.

The mixed BS 320 sends a first key agreement message including N_BS and an MSK refresh indicator for the MSK refreshing, to the MS 310 in step 301. The MS 310 determines EMSK_Hash in step 303. The EMSK_Hash is a result of a hash function for the EMSK, and used to confirm that the MS 310 and the authentication server 340 have the same EMSK. For example, the EMSK_Hash can be determined by one of hash functions as shown in equation 1.

EMSK_Hash=H(EMSK,NONCE_MS|NONCE_BS| . . . )

EMSK_Hash=H(EMSK,NONCE_MS|NONCE_BS|“EMSK_Hash”| . . . )

EMSK_Hash=H(EMSK,NONCE_MS|NONCE_BS|“EMSK_Hash”|MSID| . . . )

EMSK_Hash=H(EMSK,NONCE_MS|NONCE_BS|“EMSK_Hash”|MSNAI . . . ) (1)

In step 305, the AMS 310 determining EMSK_Hash sends a second key agreement message including the N_BS, N_MS, MSK_SN, EMSK_Hash, and Cipher-based Message Authentication Code (CMAC) digest, to the mixed BS 320. In step 307, the mixed BS 320 sends a context request message including the N_BS, the N_MS, the MSK_SN, the MSK refresh indicator, and the EMSK-Hash, to the ASN-GW 330. In step 309, the ASN-GW 330 receiving the context request message sends an authentication request message including a Mobile Station IDentifier (MSID) of the MS 310, the MSK_SN, and the EMSK_Hash to the authentication server 340. Herein, the authentication request message can be a Remote Authentication Dial-In User Service (RADIUS) Access-Request message or a WiMAX-Diameter-EAP-Request (WDER) message. In step 311, the authentication server 340 confirms based on the EMSK_Hash that the AMS 310 has the same EMSK, and then determines the MSK1 using the EMSK. For example, the MSK1 is defined as equation 2.

MSK1=KDF(EMSK,MSK_SN|MSID,512) (2)

In step 313, the authentication server 340 determining the MSK1 sends an authentication accept message including the MSK1 to the ASN-GW 330. Herein, the authentication accept message can be a RADIUS Access-Accept message or a WiMAX-Diameter-EAP-Accept (WDEA) message. In step 315, the ASN-GW 330 determines a Pairwise Master Key (PMK) with the MSK1. For example, the PMK can be defined as equation 3.

PMK=KDF(MSK,NONCE_MS|NONCE_BS|CMAC_KEY_COUNT|“PMK”,160) (3)

In step 317, the ASN-GW 330 determining the PMK sends a context report message including an Authorization Key (AK) context and an MSK refresh success indicator, to the mixed BS 320. In step 319, the mixed BS 320 receiving the context report message sends a third key agreement message including the N_BS, the N_MS, the MSK_SN, and the CMAC digest and informing of the MSK refresh success, to the MS 310.

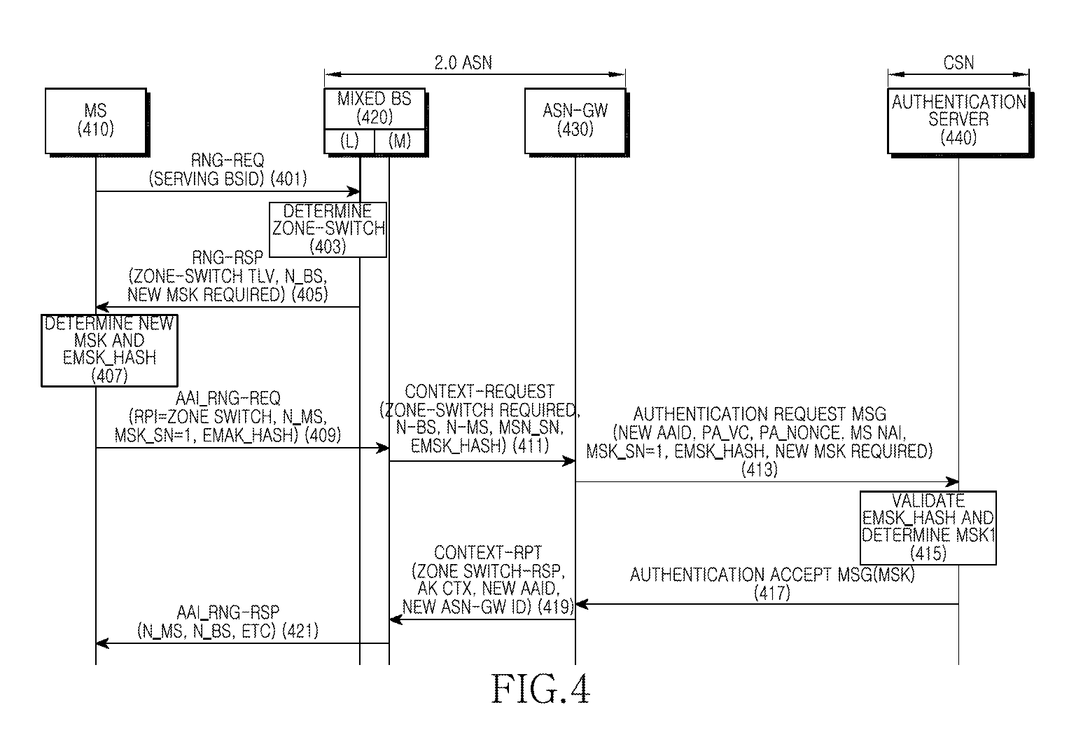

FIG. 4 is a diagram of a signal exchange for refreshing an MSK through zone switching in a wireless communication system according to an exemplary embodiment of the present invention. An MS 410 is accessible to both of the L-zone and the M-zone, a mixed BS 420 can provide both of the L-zone service and the M-zone service, and an ASN-GW 430 can function as an authenticator.

In step 401, the AMS 410 sends a RaNGing-REQuest (RNG-REQ) message including a Base Station IDentifier (BSID) of a serving BS to the mixed BS 420 over the L-zone. In step 403, the mixed BS 420 receiving the RNG-REQ message determines to switch the AMS 410 to the M-zone. Hence, the mixed BS 420 sends a RaNGing-ReSPonse (RNG-RSP) message including zone-switch indication information, N_BS, and a new MSK required, that is, an MSK refresh required, to the MS 410 over the L-zone in step 405.

In step 407, the MS 410 receiving the RNG-RSP message instructing the zone switch determines a new MSK and the EMSK_Hash. The EMSK_Hash is a result of the hash function of the EMSK, and used to confirm that the AMS 410 and the authentication server 440 have the same EMSK. For example, the EMSK_Hash can be defined as equation 1 above, and the new MSK can be determined by one of expressions in equation 4.

MSK_sn=H(EMSK,MSID|MSK_SN| . . . )

MSK_sn=H(EMSK,MSNAI|MSK_SN| . . . )

MSK_sn=H(EMSK,MSID|MSK_SN|NONCE_BS|NONCE_MS| . . . ) (4)

In step 409, the AMS 410 determining the new MSK and the EMSK_Hash sends an Advanced Air Interface (AAI)_RNG-REQ message including a Ranging Purpose Indicator (RPI) indicating the zone switch, N_MS, MSK_SN defined as 1, and the EMSK_Hash, to the mixed BS 420 over the M-zone. In step 411, the mixed BS 420 receiving the AAI_RNG-REQ message sends a context request message including the zone-switch required, the N_BS, the N_MS, the MSK_SN, and the EMSK_Hash, to the ASN-GW 430. In step 413, the ASN-GW 430 receiving the context request message sends an authentication request message including an Anchor Authenticator IDentifier (AAID) of a new authenticator, Present Authenticator Validation Code (PA_VC), PA_NONCE, Mobile Station Network Access Identity (MS NAI), MSK_SN defined as 1, the EMSK_Hash, and a new MSK required, to the authentication server 440. Herein, the authentication request message can be a RADIUS Access-Request message or a WDER message. In step 415, the authentication server 440 validates the EMSK_Hash; that is, confirms based on the EMSK_Hash that the MS 410 has the same EMSK, and then determines the MSK1 using the EMSK. For example, the MSK1 can be given by equation 5.

MSK1=KDF(EMSK,MSID[MSK_SN]) (5)

In step 417, the authentication server 440 determining the MSK1 sends an authentication accept message including the MSK1 to the ASN-GW 430. Herein, the authentication accept message can be a RADIUS Access-Accept message or a WDEA message. In step 419, the ASN-GW 430 receiving the authentication accept message sends a context report message including a zone-switch response, AK context (CXT), new AAID, and a new ASN-GW ID, to the mixed BS 420. Herein, the AK context is information required for the BS to validate the RNG-REQ message received from the AMS. In step 421, the mixed BS 420 receiving the context report message sends an AAI_RNG-RSP message including the N_MS and the N_BS to the MS 410 over the M-zone.

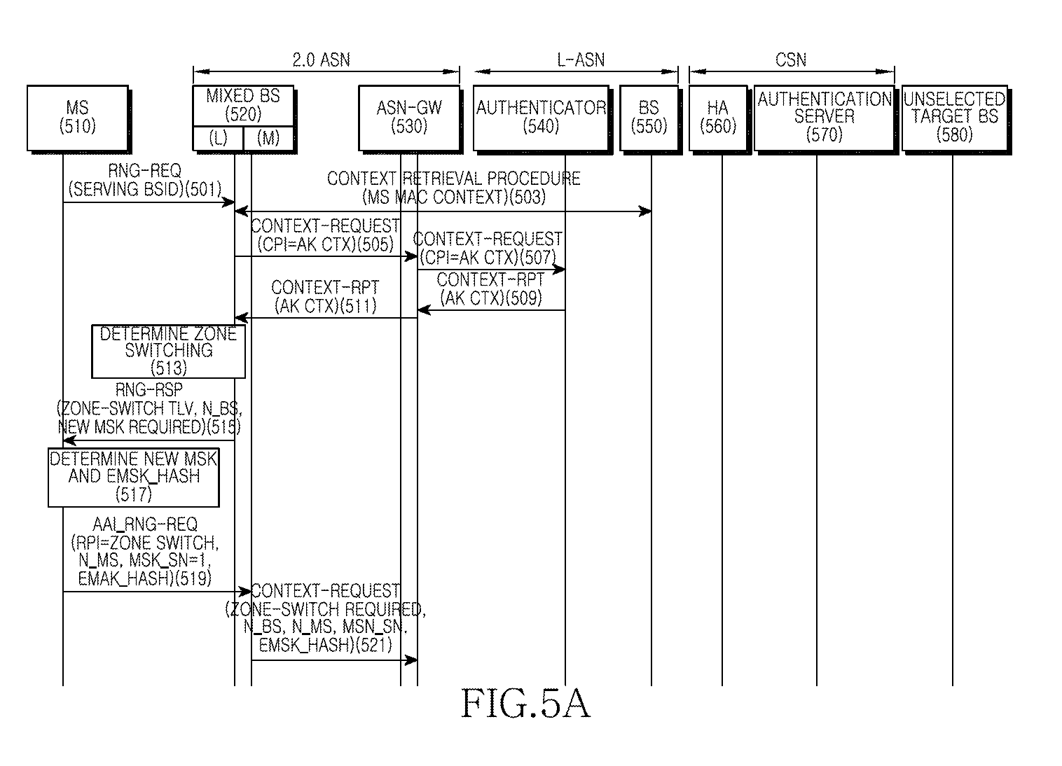

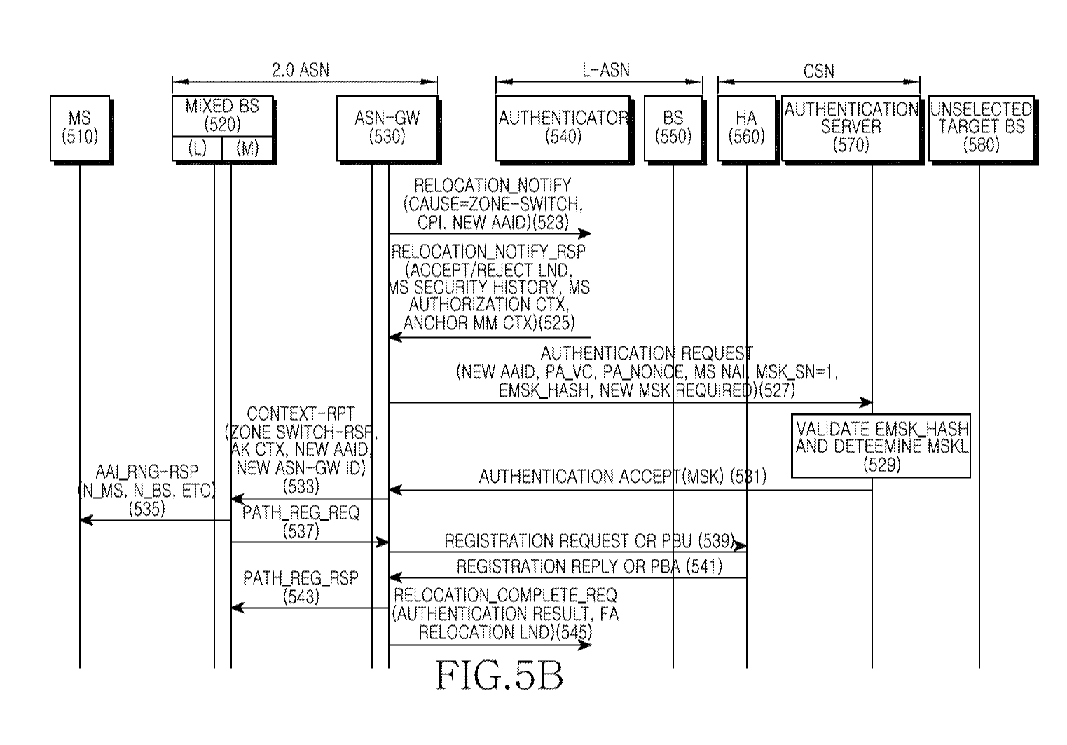

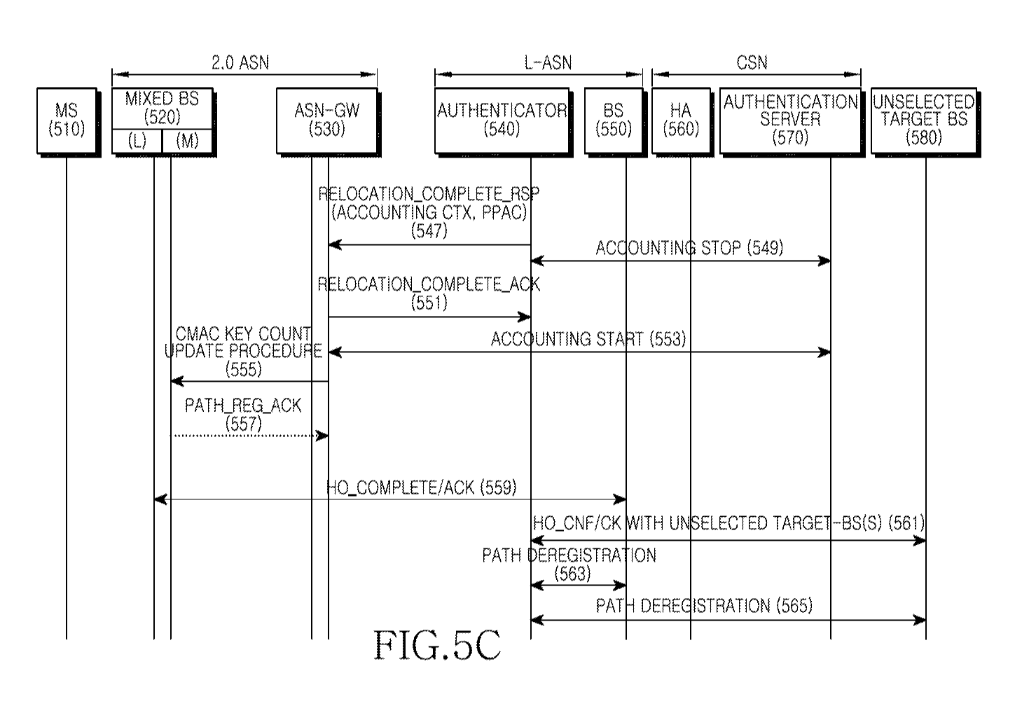

FIGS. 5A, 5B and 5C are diagrams of signal exchanges for a zone switching using an MSK refreshing in a wireless communication system according to an exemplary embodiment of the present invention.

Referring to FIG. 5A, an MS 510 is accessible to both of the L-zone and the M-zone, a mixed BS 520 can provide both of the L-zone service and the M-zone service, and an ASN-GW 530 can function as an authenticator.

In step 501, the AMS 510 sends a RNG-REQ message including the BSID of its serving BS to the mixed BS 520 over the L-zone. In step 503, the mixed BS 520 performs a context retrieval procedure to receive MAC contexts of the BS 550 and the MS 510 according to the standard of the L-zone. In step 505, the mixed BS 520 obtaining the MAC context of the AMS 510 sends a context request message including a Context Purpose Indicator (CPI) indicating the AK context, to the ASN-GW 530 according to the standard of the L-zone. In step 507, the ASN-GW 530 sends the context request message including the CPI indicating the AK context, to the authenticator 540 belonging to the L-ASN. In step 509, the authenticator 540 receiving the context request message sends a context report message including the AK context to the ASN-GW 530. In step 511, the ASN-GW 530 obtaining the AK context sends a context report message including the AK context to the mixed BS 520. In step 513, the mixed BS 520 determines to switch the MS 510 to the M-zone. Hence, the mixed BS 520 sends an RNG-RSP message including the zone-switch indication information, N_BS, and new MSK required; that is, MSK refresh required, to the MS 510 over the L-zone in step 515. In step 517, the MS 510 receiving the RNG-RSP message indicating the zone switching, determines the new MSK and the EMSK_Hash. In step 519, the MS 510 determining the new MSK and the EMSK_Hash sends an AAI_RNG-REQ message including a Ranging Purpose Indicator (RPI) indicating the zone switch, N_MS, MSK_SN defined as 1, and the EMSK_Hash, to the mixed BS 520 over the M-zone. In step 521, the mixed BS 520 receiving the AAI_RNG-REQ message sends a context request message including the zone-switch required, the N_BS, the N_MS, the MSK_SN, and the EMSK_Hash, to the ASN-GW 530.

Referring to FIG. 5B, in step 523, the ASN-GW 530 receiving the context request message transmits a relocation notify message including a cause indicator set to the zone switch, a CPI, and a new AAID, to the authenticator 540 of the L-zone. In step 525, the authenticator 540 sends a relocation notify response message including an accept/reject indicator, an MS security history, MS authorization context, and anchor MM context, to the ASN-GW 530.

In step 527, the ASN-GW 530 receiving the relocation notify response message sends an authentication request message including new AAID, PA_VC, PA_NONCE, MS NAI, MSK_SN set to 1, the EMSK_Hash, and new MSK required, to the authentication server 570. Herein, the authentication request message can be a RADIUS Access-Request message or a WDER message. In step 529, the authentication server 570 validates the EMSK_Hash and determines the MSK1. For example, the MSK1 is given by equation 6.

MSK1=KDF(MSK_{—}RK,MSID[MSK_SN]) (6)

In step 531, the authentication server 570 determining the MSK1 sends an authentication accept message including the MSK to the ASN-GW 530. Herein, the authentication accept message can be a RADIUS Access-Accept message or a WDEA message. In step 533, the ASN-GW 530 receiving the authentication accept message sends a context report message including a zone-switch response, AK context, new AAID, and new ASN-GW ID, to the mixed BS 520. In step 535, the mixed BS 520 receiving the context report message sends an AAI_RNG-RSP message including the N_MS and the N_BS to the MS 510 over the M-zone.

In step 537, the mixed BS 520 sends a Path Registration Request Path_Reg_Req message to the ASN-GW 530. In step 539, the ASN-GW 530 receiving the Path_Reg_Req message sends a registration request message or a Proxy Bind Update (PBU) message to a Home Agent (HA) 560. In step 541, the HA 560 sends a registration reply message or a Proxy Bind Acknowledge (PBA) message to ASN-GW 530. In step 543, the ASN-GW 530 sends a Path_Reg_Response (Rsp) message to the mixed BS 520. In step 545, the ASN-GW 530 transmits a relocation complete request message including the authentication result and Frequency Assignment (FA) relocation indicator, to the authenticator 540 of the L-ASN. Herein, the FA relocation indicator indicates whether the FA relocation is successful.

Referring to FIG. 5C, in step 547, the authenticator 540 sends a relocation complete response message including accounting context and PrePaid Accounting Capability (PPAC) to the ASN-GW 530. In step 549, the authenticator 540 performs an accounting stop procedure with the authentication server 570. In step 551, the ASN-GW 530 receiving the relocation complete response message sends a relocation complete ACKnowledge (ACK) to the authenticator 540. In step 553, the ASN-GW 530 performs an accounting start procedure with the authentication server 570. In step 555, the ASN-GW 530 and the mixed BS 520 conduct a CMAC key count update procedure. In step 557, the mixed BS 520 transmits a Path_Reg_Ack to the ASN-GW 530. In step 559, the mixed BS 520 informs of and confirms the handover completion with the BS 550 according to the standard of the L-zone. In step 561, the authenticator 540 performs a handover result confirm procedure with an unselected target BS 580. The authenticator 540 conducts a path deregistration procedure with the BS 550 in step 563, and conducts a path deregistration procedure with the unselected target BS 580 in step 565.

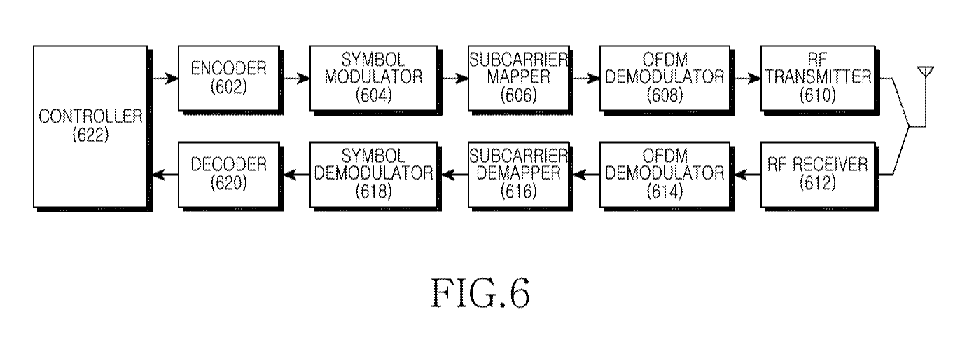

FIG. 6 is a block diagram of an MS in a broadband wireless communication system according to an exemplary embodiment of the present invention.

Referring to FIG. 6, the MS includes an encoder 602, a symbol modulator 604, a subcarrier mapper 606, an OFDM modulator 608, an RF transmitter 610, an RF receiver 612, an OFDM demodulator 614, a subcarrier demapper 616, a symbol demodulator 618, a decoder 620, and a controller 622.

The encoder 602 channel-codes a transmit bit stream. The symbol modulator 604 modulates and converts the channel-coded bit stream to complex symbols. The subcarrier mapper 606 maps the complex symbols into the frequency domain. The OFDM modulator 608 converts the complex symbols mapped to the frequency domain to a time-domain signal using an Inverse Fast Fourier Transform (IFFT) process, and constitutes OFDM symbols by inserting a Cyclic Prefix (CP). The RF transmitter 610 up-converts the baseband signal to an RF signal and transmits the RF signal via an antenna.

The RF receiver 612 down-converts an RF signal received via the antenna to a baseband signal. The OFDM demodulator 614 divides the signal output from the RF receiver 612 to OFDM symbols, and restores the complex symbols mapped to the frequency domain using an FFT process. The subcarrier demapper 616 classifies the complex symbols mapped to the frequency domain based on the processing unit. The symbol demodulator 618 demodulates and converts the complex symbols to the bit stream. The decoder 620 restores the information bit stream by channel-decoding the bit stream.

The controller 622 controls the functions of the MS. More particularly, the controller 622 controls the MSK refreshing procedure of the MS. The controller 622 controls to refresh the MSK using the EMSK without the EAP re-authentication. Operations of the controller 622 for the MSK refresh are described below.

To refresh the MSK through the key agreement procedure, when the first key agreement message including N_BS and the MSK refresh indicator is received from the BS for the MSK refresh, the controller 622 determines the EMSK_Hash. For example, the EMSK_Hash is determined by one of the expressions of equation 1. Next, the controller 622 transmits the second key agreement message including the N_BS, the N_MS, the MSK_SN, the EMSK_Hash, and the CMAC digest, to the BS via the encoder 602, the symbol modulator 604, the subcarrier mapper 606, the OFDM modulator 608, and the RF transmitter 610. Next, the controller 622 confirms that the third key agreement message including the N_BS, the N_MS, the MSK_SN, and the CMAC digest and informing of the successful MSK refresh is received from the BS.

To refresh the MSK through the zone-switching from the L-zone to the M-zone, the controller 622 controls to send the RNG-REQ message including the BSID of the serving BS, to the BS over the L-zone. Next, when the RNG-RSP message including the zone-switch indication information, the N_BS, and the new MSK required; that is, the MSK refresh required is received from the BS, the controller 622 determines the new MSK and the EMSK_Hash. For instance, the new MSK is determined by one of the expressions of equation 4. Next, the controller 622 controls to send the AAI_RNG-REQ message including the RPI indicating the zone switch, the N_MS, the MSK_SN defined as 1, and the EMSK_Hash, to the BS over the M-zone. The controller 622 confirms that the AAI_RNG-RSP message including the N_MS and the N_BS is received from the BS.

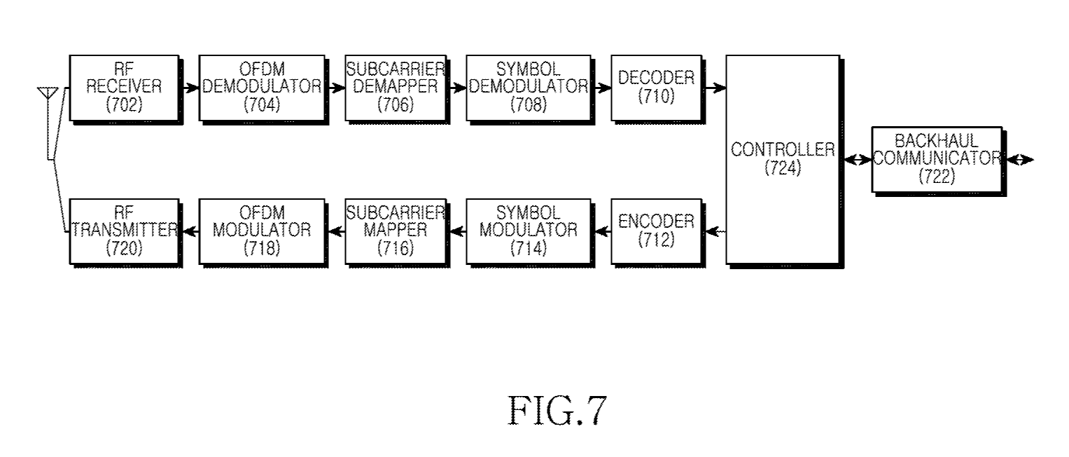

FIG. 7 is a block diagram of a mixed BS in a broadband wireless communication system according to an exemplary embodiment of the present invention.

Referring to FIG. 7, the BS includes an RF receiver 702, an OFDM modulator 704, a subcarrier demapper 706, a symbol demodulator 708, a decoder 710, an encoder 712, a symbol modulator 714, a subcarrier mapper 716, an OFDM modulator 718, an RF transmitter 720, a backhaul communicator 722, and a controller 724.

The RF receiver 702 down-converts an RF signal received via an antenna to a baseband signal. The OFDM demodulator 704 divides the signal output from the RF receiver 702 to OFDM symbols, and restores the complex symbols mapped to the frequency domain using the FFT process. The subcarrier demapper 706 divides the complex symbols mapped to the frequency domain based on the processing unit. The symbol demodulator 708 demodulates and converts the complex symbols to the bit stream. The decoder 710 restores the information bit stream by channel-decoding the bit stream.

The encoder 712 channel-encodes a transmit bit stream. The symbol modulator 714 modulates and converts the channel-coded bit stream to complex symbols. The subcarrier mapper 716 maps the complex symbols into the frequency domain. The OFDM modulator 718 converts the complex symbols mapped to the frequency domain to a time-domain signal using the IFFT process, and constitutes OFDM symbols by inserting the CP. The RF transmitter 720 up-converts the baseband signal to an RF signal and transmits the RF signal via the antenna. The backhaul communicator 722 provides the interface for the BS to communicate with other nodes in the network.

The controller 724 controls the functions of the BS. More specifically, the controller 724 controls the MSK refresh procedure of the MS. The controller 724 controls to refresh the MSK using the EMSK without the EAP re-authorization. Operations of the controller 724 for the MSK refresh are described below.

To refresh the MSK through the key agreement procedure, the controller 724 controls to send the first key agreement message including N_BS and the MSK refresh indicator, to the MS for the MSK refresh. Next, when the second key agreement message including the N_BS, the N_MS, the MSK_SN, the EMSK_Hash, and the CMAC digest, from the MS, the controller 724 controls to send the context request message including the N_BS, the N_MS, the MSK_SN, the MSK refresh indicator, and the EMSK_Hash to the ASN-GW via the backhaul communicator 722. When the context report message including the AK context and the MSK refresh success indicator is received from the ASN-GW, the controller 724 controls to transmit the third key agreement message including the N_BS, the N_MS, the MSK_SN, and the CMAC digest and informing of the successful MSK refresh, to the MS.

To refresh the MSK through the zone-switching from the L-zone to the M-zone, the controller 724 receives the RNG-REQ message over the L-zone and then determines the zone switching of the MS. Hence, the controller 724 controls to send the RNG-RSP message including the zone-switch indication information, the N_BS, and the new MSK required; that is, the MSK refresh required, over the L-zone. Next, when the AAI_RNG-REQ message including the RPI indicating the zone switch, the N_MS, the MSK_SN set to 1, and the EMSK_Hash, is received from the MS over the M-zone, the controller 724 controls to transmit the context request message including the zone-switch required, the N_BS, the N_MS, the MSK_SN, and the EMSK_Hash, to the ASN-GW. When receiving the context report message including the zone-switch response, the AK context, the new AAID, and the new ASN-GW ID from the ASN-GW, the controller 724 controls to send the AAI_RNG-RSP message including the N_MS and the N_BS to the MS over the M-zone.

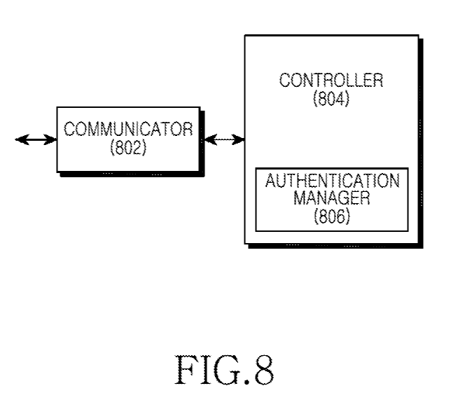

FIG. 8 is a block diagram of an ASN-GW in a broadband wireless communication system according to an exemplary embodiment of the present invention.

Referring to FIG. 8, the ASN-GW includes a communicator 802 and a controller 804.

The communicator 802 provides the interface for the ASN-GW to communicate with other nodes of the network. The controller 804 controls functions of the ASN-GW. An authentication manager 806 of the controller 804, which functions as the authenticator, stores authentication information of the MSs and provides the authentication information according to the request of the other node. In particular, the controller 804 controls the MSK refresh procedure of the MS. In so doing, the controller 804 controls to refresh the MSK using the EMSK without the EAP re-authorization. To refresh the MSK, the controller 804 operates as described below.

To refresh the MSK through the key agreement, when receiving the context request message including the N_BS, the N_MS, the MSK_SN, the MSK refresh indicator, and the EMSK_Hash from the BS, the controller 804 controls to send the authentication request message including the MSID, the MSK_SN, and the EMSK_Hash to the authentication server via the communicator 802. Next, when receiving the authentication accept message including the MSK from the authentication server, the controller 804 determines the PMK. For instance, the PMK is determined as shown in equation 3. The controller 804 controls to send the context report message including the AK context and the MSK refresh success indicator to the BS.

To refresh the MSK through the zone switch from the L-zone to the M-zone, when receiving the context request message including the zone-switch required, the N_BS, the N_MS, the MSK_SN, and the EMSK_Hash from the BS, the controller 804 controls to send the authentication request message including the AAID of the new authenticator, the PA_VC, the PA_NONCE, the MS NAI, the MSK_SN set to 1, the EMSK_Hash, and the new MSK required, to the authentication server. Next, when receiving the authentication accept message including the MSK from the authentication server, the controller 804 controls to send the context report message including the zone-switch response, AK context, the new AAID, and the new ASN-GW ID to the BS.

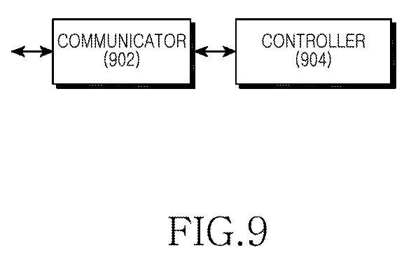

FIG. 9 is a block diagram of an authentication server in a broadband wireless communication system according to an exemplary embodiment of the present invention.

Referring to FIG. 9, the authentication server includes a communicator 902 and a controller 904.

The communicator 902 provides the interface for the authentication server to communicate with other nodes of the network. The controller 904 controls functions of the authentication server. The controller 904 controls the MSK refresh of the MS. In so doing, the controller 904 controls to refresh the MSK using the EMSK without the EAP re-authentication. To refresh the MSK, the controller 904 operates as follows.

To refresh the MSK through the key agreement, when receiving the authentication request message including the MSID of the MS, the MSK_SN, and the EMSK_Hash from the ASN-GW, the controller 904 determines the MSK1. For example, the MSK1 is determined as shown in equation 2. After determining the MSK1, the controller 904 controls to transmit the authentication accept message including the MSK to the ASN-GW via the communicator 902.

To refresh the MSK through the zone switch from the L-zone to the M-zone, when receiving the authentication request message including the AAID of the new authenticator, the PA_VC, the PA_NONCE, the MS NAI, the MSK_SN set to 1, the EMSK_Hash, and the new MSK required from the ASN-GW, the controller 904 validates the EMSK_Hash and determines the MSK1. For example, the MSK1 is determined as shown in equation 4. Next, the controller 904 controls to send the authentication accept message including the MSK to the ASN-GW.

In the wireless communication system according to the present invention, by refreshing the MSK using the EMSK without the EAP re-authentication, the time delay taken to refresh the MSK is reduced.

Although the present invention has been described with an exemplary embodiment, various changes and modifications may be made without departing from the scope or spirit of the invention, as would be understood by one skilled in the art. It is intended that the present disclosure encompass such changes and modifications as fall within the scope of the appended claims.

What is claimed is:

1. A method for refreshing a Master Session Key (MSK) in a wireless communication system, the method comprising:
when receiving a first Media Access Control (MAC) message comprising MSK refresh indication information from a Base Station (BS), generating, by a Mobile Station (MS), Extended Master Session Key (EMSK)_Hash by applying a hash function to an EMSK and sending a second MAC message comprising the EMSK_Hash;
sending, by the BS, a context request message comprising the EMSK_Hash to an Access Service Network GateWay (ASN-GW);
sending, by the ASN-GW, an authentication request message comprising the EMSK_Hash to an authentication server;
when receiving the authentication request message comprising the EMSK_Hash, confirming, by the authentication server, the same EMSK as the MS based on the EMSK_Hash, determining an MSK1 using the EMSK, and sending an authentication accept message comprising the MSK1 to the ASN-GW; and
sending, by the ASN-GW, a context report message comprising an Authorization Key (AK) context to the BS.

2. The method of claim 1, wherein the first MAC message comprises a first key agreement message, and
the second MAC message comprises a second key agreement message.

3. The method of claim 2, further comprising:
after receiving the authentication accept message, generating, at the ASN-GW, a Pairwise Master Key (PMK) using the MSK1.

4. The method of claim 3, wherein the PMK is generated based on the following equation:
PMK=KDF(MSK,NONCE_MS|NONCE_BS|CMAC_KEY_COUNT|“PMK”,160)

5. The method of claim 1, wherein the first MAC message comprises a RaNGing-ReSPonse (RNG-RSP) message comprising zone-switch indication information, and
the second MAC message comprises a RaNGing-REQuest (RNG-REQ) message indicating the zone-switch.

6. The method of claim 5, further comprising:
before sending the first MAC message, receiving, at the BS, a RNG-REQ message from the MS and determining the zone switching.

7. The method of claim 1, wherein the EMKS_Hash is determined by one of the following equations:
EMSK_Hash=H(EMSK,NONCE_MS|NONCE_BS| . . . )
EMSK_Hash=H(EMSK,NONCE_MS|NONCE_BS|“EMSK_Hash”| . . . )
EMSK_Hash=H(EMSK,NONCE_MS|NONCE_BS|“EMSK_Hash”|MSID| . . . )
EMSK_Hash=H(EMSK,NONCE_MS|NONCE_BS|“EMSK_Hash”|MSNAI . . . )

8. The method of claim 1, wherein the MSK1 is determined by the following equation:
MSK1=KDF(EMSK,MSK_SN|MSID,512).

9. The method of claim 1, further comprising:
integrating, by the BS, an existing standard and a new standard, the new standard being advanced from the existing standard.

10. The method of claim 9, wherein the existing standard comprises IEEE 802.16e, the new standard comprises IEEE 802.16m, and the integrated standard comprises IEEE 802.16e/16m.

11. The method of claim 9, further comprising:
handing over between a zone of the existing standard and a zone of the integrated existing and new standards.

12. A wireless communication system comprising:
a Mobile Station (MS) for, when receiving a first Media Access Control (MAC) message comprising Master Session Key (MSK) refresh indication information from a Base Station (BS), generating an Extended Master Session Key (EMSK)_Hash by applying a hash function to an EMSK and sending a second MAC message comprising the EMSK_Hash;
the BS for sending a context request message comprising the EMSK_Hash to an Access Service Network GateWay (ASN-GW);
the ASN-GW for sending an authentication request message comprising the EMSK_Hash to an authentication server, and when receiving an authentication accept message comprising an MSK1 from the authentication server, sending a context report message comprising an Authorization Key (AK) context to the BS; and
the authentication server for, when receiving the authentication request message comprising the EMSK_Hash from the ASN-GW, confirming the same EMSK as the MS based on the EMSK_Hash, determining the MSK1 using the EMSK, and sending the authentication accept message comprising the MSK1 to the ASN-GW.

13. The wireless communication system of claim 12, wherein the first MAC message comprises a first key agreement message, and
the second MAC message comprises a second key agreement message.

14. The wireless communication system of claim 13, wherein, after receiving the authentication accept message, the ASN-GW generates a Pairwise Master Key (PMK) using the MSK1.

15. The wireless communication system of claim 14, wherein the PMK is generated based on the following equation:
PMK=KDF(MSK,NONCE_MS|NONCE_BS|CMAC_KEY_COUNT|“PMK”,160)

16. The wireless communication system of claim 12, wherein the first MAC message comprises a RaNGing-ReSPonse (RNG-RSP) message comprising zone-switch indication information, and
the second MAC message comprises a RaNGing-REQuest (RNG-REQ) message indicating the zone-switch.

17. The wireless communication system of claim 16, wherein, before sending the first MAC message, the BS receives a RNG-REQ message from the MS and determines the zone switching.

18. The wireless communication system of claim 12, wherein the EMSK_Hash is determined by one of the following equations:
EMSK_Hash=H(EMSK,NONCE_MS|NONCE_BS| . . . )
EMSK_Hash=H(EMSK,NONCE_MS|NONCE_BS|“EMSK_Hash”| . . . )
EMSK_Hash=H(EMSK,NONCE_MS|NONCE_BS|“EMSK_Hash”|MSID| . . . )
EMSK_Hash=H(EMSK,NONCE_MS|NONCE_BS|“EMSK_Hash”|MSNAI . . . )

19. The wireless communication system of claim 12, wherein the MSK1 is determined by the following equation:
MSK1=KDF(EMSK,MSK_SN|MSID,512).
